(19) United States
(12) Patent Application Publication
(10) Pub. No.: US 2026/0243895 A1
(43) Pub. Date: Aug. 20, 2026

(54) DISTANCE MEASUREMENT METHOD, DISTANCE MEASUREMENT DEVICE, AND DISTANCE MEASUREMENT SYSTEM

(71) Applicant: Hitachi High-Tech Corporation, Tokyo (JP)

(72) Inventors: Tatsuo HARIYAMA, Tokyo (JP); Masahiro WATANABE, Tokyo (JP); Kenji MARUNO, Tokyo (JP); Hirohito AKIYAMA, Tokyo (JP); Hidehiko KANDO, Tokyo (JP)

(21) Appl. No.: 18/995,273

(22) PCT Filed: May 15, 2023
(86) PCT No.: PCT/JP2023/018154

§ 371 Date: Jan. 16, 2025

(30) Foreign Application Priority Data
Sep. 27, 2022 (JP) 2022-153536

(51) Int. Cl. G01S 17/32; G01S 7/481

(52) U.S. Cl. CPC G01S 17/32; G01S 7/4818

(57) ABSTRACT

Provided are a distance measurement device and a distance measurement method capable of reducing a distance error induced by polarization. A distance measurement method includes: branching light generated by a laser light source into a reference optical system and a measurement optical system; detecting a reference optical path measurement beat signal from reference light that passed through the reference optical system; detecting a measurement optical path measurement beat signal from measurement light obtained in the measurement optical system via a measurement target; and measuring a distance to the measurement target based on the measurement optical path measurement beat signal and the reference optical path measurement beat signal. A polarization-induced distance error reduction element is provided in one or both of the reference optical system and the measurement optical system.

### TECHNICAL FIELD

The present invention relates to a distance measurement method, a distance measurement device, and a distance measurement system for measuring a distance to a target in a non-contact manner using light.

### BACKGROUND ART

With regard to a method for measuring a distance to a target in a non-contact manner using light, in PTL 1, in order to improve robustness against a change in ambient environment temperature, a reference fiber interferometer is placed into a thermally insulated storage box, an internal temperature is monitored, and a change in optical path length due to heat of a reference fiber is corrected, thereby calculating an accurate distance.

### CITATION LIST

### Patent Literature

PTL 1: JP6835919B

### SUMMARY OF INVENTION

### Technical Problem

According to the method for measuring a distance to a target in a non-contact manner using light, such as PTL 1, there is a problem that when the ambient environment temperature changes and a temperature of an optical fiber constituting a distance measurement unit changes, a polarization state of light passing through the optical fiber changes and a distance error is generated in a light interference signal.

Accordingly, an object of the invention is to provide a distance measurement method, a distance measurement device, and a distance measurement system capable of reducing a distance error induced by polarization.

### Solution to Problem

In view of the above, the invention provides “a distance measurement method including: branching light generated by a laser light source into a reference optical system and a measurement optical system; detecting a reference optical path measurement beat signal from reference light that passed through the reference optical system; detecting a measurement optical path measurement beat signal from measurement light obtained d in the measurement optical system via a measurement target; and measuring a distance to the measurement target based on the measurement optical path measurement beat signal and the reference optical path measurement beat signal, in which polarization-induced distance error reduction element is provided in one or both of the reference optical system and the measurement optical system”.

In addition, the invention provides distance measurement device including: a light branching unit configured to branch light generated by a laser light source; a reference optical system configured to obtain reference light serving as a reference of a distance by guiding one of the branched light; a measurement optical system configured to obtain, as measurement light, reflected light after the other one of the branched light is guided to irradiate a measurement target; a first light receiving unit configured to receive the reference light that passed through the reference optical system and detect a reference optical path measurement beat signal; a second light receiving unit configured to receive the measurement light reflected by the measurement target in the measurement optical system and detect a measurement optical path measurement beat signal; and a polarization-induced distance error reduction element provided in one or both of the reference optical system and the measurement optical system, in which a distance to the measurement target is measured based on the measurement optical path measurement beat signal and the reference optical path measurement beat signal”.

In addition, the invention provides “a distance measurement system including: a light branching unit configured to branch light generated by a laser light source; a reference optical system configured to obtain reference light serving as a reference of a distance by guiding one of the branched light; a measurement optical system configured to obtain, as measurement light, reflected light after the other one of the branched light is guided to irradiate a measurement target; a first light receiving unit configured to receive the reference light that passed through the reference optical system and detect a reference optical path measurement beat signal; a second light receiving unit configured to receive the measurement light reflected by the measurement target in the measurement optical system and detect a measurement optical path measurement beat signal; a polarization-induced distance error reduction element provided in one or both of the reference optical system and the measurement optical system; and a scanning mechanism configured to perform, when the measurement target is irradiated with irradiation light in the measurement optical system, scanning with the irradiation light one-dimensionally, two-dimensionally, or three-dimensionally, in which a distance to the measurement target is measured based on the measurement optical path measurement beat signal and the reference optical path measurement beat signal”.

### Advantageous Effects of Invention

According to the invention, even when an ambient environment temperature of a distance measurement unit changes, it is possible to prevent a distance error induced by polarization, and to accurately measure a distance to a target.

### BRIEF DESCRIPTION OF DRAWINGS

FIG. 1 is a diagram showing a configuration example of a distance measurement device 100 according to Embodiment 1 of the invention.

FIG. 2 is a diagram showing a principle of an FMCW method according to Embodiment 1.

FIG. 3a is a diagram showing an interference beat signal obtained by a light receiver.

FIG. 3b is a diagram showing a result obtained by performing FFT on the interference beat signal.

FIG. 4a is a diagram showing an interference beat signal obtained by the light receiver.

FIG. 4b is a diagram showing a result obtained by performing FFT on the beat signal.

FIG. 4c is a diagram showing a distance error generated when heat is applied to an optical fiber.

FIG. 5 is a diagram showing a configuration example of the distance measurement device 100 according to Embodiment 2 of the invention.

FIG. 6a is a diagram showing an interference beat signal obtained by a light receiver.

FIG. 6b is a diagram showing a result obtained by performing FFT on the beat signal.

FIG. 6c is a diagram showing a distance error generated when heat is applied to an optical fiber.

FIG. 7 is a diagram showing a configuration example of the distance measurement device 100 according to Embodiment 3 of the invention.

FIG. 8 is a diagram showing a configuration example of the distance measurement device 100 according to Embodiment 4 of the invention.

FIG. 9a is a diagram showing a result obtained by performing FFT on an interference beat signal obtained by the light receiver.

FIG. 9b is a diagram showing a distance error generated when heat is applied to an optical fiber.

FIG. 10 is a diagram showing a configuration example of the distance measurement device 100 according to Embodiment 5 of the invention.

FIG. 11 is a diagram showing a configuration example of the distance measurement device 100 according to Embodiment 6 of the invention.

FIG. 12 is a diagram showing a configuration example of the distance measurement device 100 according to Embodiment 7 of the invention.

FIG. 13 is a diagram showing an example of a configuration in which a polarizer is inserted into a reference optical system according to Embodiment 7.

FIG. 14 is a diagram showing an example of a configuration in which an interferometer of the reference optical system according to Embodiment 7 is covered with a heat insulating box and a temperature sensor is provided.

FIG. 15a is a diagram showing a configuration example of a distance measurement system according to Embodiment 8 of the invention.

FIG. 15b is a diagram showing another configuration example of the distance measurement system according to Embodiment 8 of the invention.

FIG. 16 is a diagram showing a configuration example of a distance measurement system according to Embodiment 9 of the invention.

FIG. 17 is a diagram showing a configuration example of a distance measurement system according to Embodiment 10 of the invention.

FIG. 18 is a diagram showing a configuration example of a distance measurement system according to Embodiment 11 of the invention.

FIG. 19 is a diagram showing a principle of switching an irradiation direction by polarized light in Embodiment 11.

FIG. 20 is a diagram showing a configuration example of a distance measurement system according to Embodiment 12 of the invention.

FIG. 21 is a diagram showing a configuration example of the distance measurement system according to Embodiment 12.

FIG. 22 is a diagram showing a configuration example different from that of the distance measurement system in FIG. 18.

FIG. 23 is a diagram showing an FFT result of a detection beat signal obtained by the configuration in FIG. 22.

FIG. 24 is a diagram showing a processing flow of origin correction.

FIG. 25 is a diagram showing another form of a polarizer according to Embodiment 1.

FIG. 26 is a diagram showing another form of the polarizer according to Embodiment 1.

FIG. 27 is a diagram showing another form of a polarization beam splitter/combiner according to Embodiment 4.

### DESCRIPTION OF EMBODIMENTS

Hereinafter, embodiments of the invention will be described with reference to the drawings. Here, the embodiments are examples for describing the invention, and are omitted and simplified as appropriate for clarity of description. The invention can be implemented in various other forms. Unless otherwise specified, each component may be single or plural.

In order to facilitate understanding of the invention, a position, size, shape, range, and the like of each component shown in the drawings may not represent an actual position, size, shape, range, and the like. Therefore, the invention is not necessarily limited to the position, size, shape, range, or the like disclosed in the drawings.

When there are a plurality of components having the same or similar function, the same reference sign may be assigned with different subscripts. When it is not necessary to distinguish the plurality of components, the description may be made by omitting the subscripts.

In the embodiments, processing performed by executing a program may be described. Here, a computer executes the program by a processor (for example, a CPU or a GPU) and performs processing defined by the program using a storage resource (for example, a memory), an interface device (for example, a communication port), or the like. Therefore, a subject of the processing performed by executing the program may be the processor. Similarly, the subject of the processing performed by executing the program may be a controller, a device, a system, a computer, or a node including the processor. The subject of the processing executed by executing the program may be a calculation unit and may include a dedicated circuit that executes specific processing. Here, the dedicated circuit is, for example, a field programmable gate array (FPGA), an application specific integrated circuit (ASIC), and a complex programmable logic device (CPLD).

The program may be installed in the computer from a program source. The program source may be, for example, a program distribution server or a computer-readable storage medium. When the program source is the program distribution server, the program n distribution server may include a processor and a storage resource for storing a program to be distributed, and the processor of the program distribution server may distribute a program to be distributed to another computer. In the embodiments, two or more programs may be implemented as one program, or one program may be implemented as two or more programs.

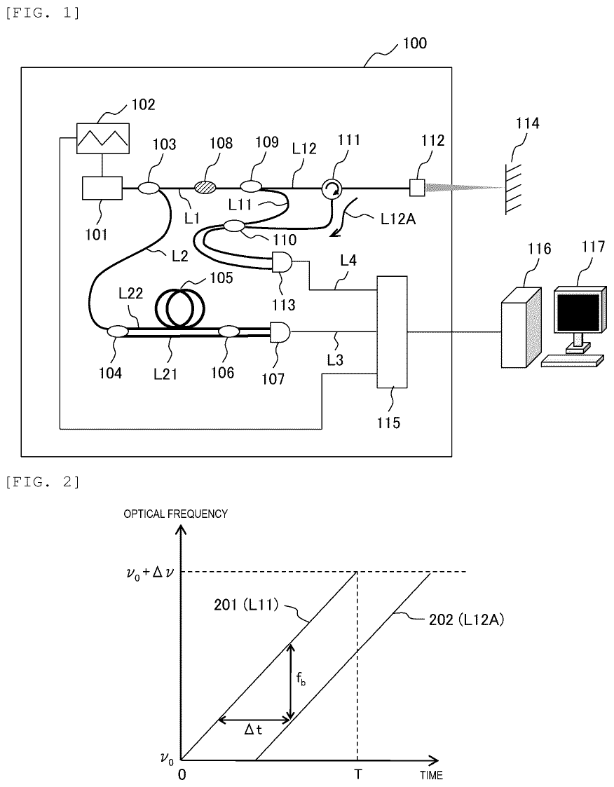

The invention described below provides a polarization-induced distance error reduction element in an optical path to reduce a distance error induced by polarization. A method for implementing the polarization-induced distance error reduction element includes a method using an orthogonal polarization component attenuating element, and a method using an inter-polarization component optical path difference generating element. The former will be described in Embodiment 1 to Embodiment 3 with reference to FIGS. 1 to 7, and the latter will be described in Embodiment 4 to Embodiment 8 with reference to FIGS. 8 to 15. In addition, a configuration example of a shape measurement system will be described with reference to FIGS. 16 to 24 in Embodiment 9 to Embodiment 13.

### Embodiment 1

In Embodiment 1 to Embodiment 3, the method using the orthogonal polarization component attenuating element will be described. First, FIG. 1 shows a configuration example of a distance measurement device 100 according to Embodiment 1 of the invention. Here, a distance measurement method using an optical path difference is based on a frequency modulated continuous wave (FMCW) method.

In the distance measurement device 100 based on the FMCW method, first, a sweep waveform signal is transmitted from a distance measurement control unit 115 to an oscillator 102. The oscillator 102 injects a triangular wave current into a laser light source 101 to modulate a drive current. As a result, the laser light source 101 generates frequency modulated (FM) light subjected to frequency sweep at a constant modulation speed over time. The laser light source 101 may be configured as a semiconductor laser device with an external resonator, and a resonance wavelength of the laser light source 101 may be changed by a triangular wave control signal from the oscillator 102. As a result, the FM light temporally subjected to the frequency sweep is generated from the laser light source 101 over time.

Next, the generated FM light is split into light L1 and light L2 by an optical fiber coupler 103. Optical fiber couplers 103, 104, 106, 109, and 110 may be beam splitters. The L2, which is one of the split light, is guided to a reference optical system and further split into light L21 and light L22 by the optical fiber coupler 104. The split light L21 and light L22 are combined by the optical fiber coupler 106 after a certain optical path difference is provided by the optical fiber 105, and are received as light L3 by a light receiver 107. This is a configuration of a Mach-Zehnder interferometer, and the constant beat signal L3 proportional to the optical path difference is generated in the light receiver 107.

The L1, which is the other one of the light split by the optical fiber coupler 103, has a specific polarization component passing through a polarizer 108 (the orthogonal polarization component attenuating element), and is split into light L11 and light L12 by the optical fiber coupler 109. The light L11 is reference light and is guided to the optical fiber coupler 110, and the light L12 passes through a circulator 111 and emits to a space from a fiber focuser 112, to irradiate a measurement target 114.

Light L12A reflected by the target 114 passes through the fiber focuser 112 again, passes through another port of the circulator 111, and passes through the optical fiber coupler 110, and a light receiver 113 detects a beat signal L4 generated by interference between the reference light L11 and the measurement light L12A.

The distance measurement control unit 115 performs A/D conversion on the measurement beat signal L4 received by the light receiver 113 using the reference beat signal L3 received by the light receiver 107 as a sampling clock. Alternatively, the reference beat signal L3 and the measurement beat] signal L4 4 are sampled at a constant sampling clock. More specifically, the reference beat signal L3 is subjected to Hilbert transform to create a signal with a phase shift of 90 degrees. Since a local phase of the signal can be obtained from the reference signal before and after the Hilbert transform, a timing at which the reference signal has a constant phase can be obtained by interpolating the phase.

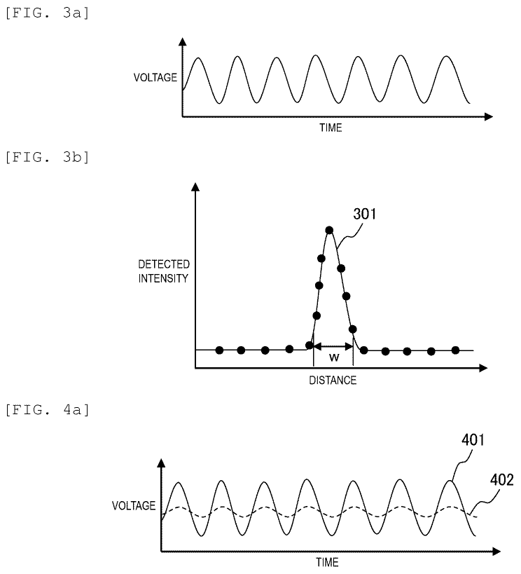

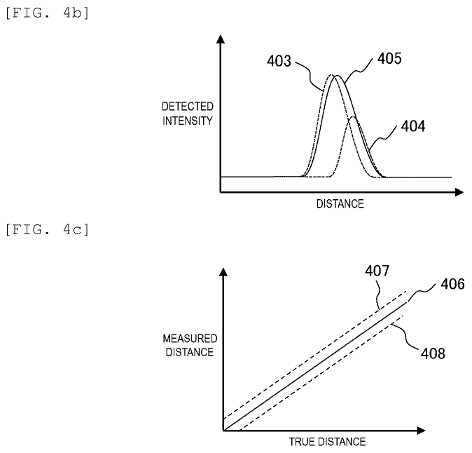

By performing interpolation sampling on the measurement beat signal L4 in accordance with this timing, it is possible to perform resampling on the measurement signal L4 with reference to the reference signal L3. Alternatively, the measurement signal L4 is sampled and subjected to the A/D conversion by an AD/DA converter in the distance measurement control unit 115 using the reference beat signal L3 as the sampling clock, and the same effect is obtained. Details of a distance calculation method from the beat signal will be described with reference to FIGS. 2 and 3, and distance measuring data analyzed by the distance measurement control unit 115 is transmitted to a control PC 116 and is displayed on a display unit 117.

Analysis of the beat signal will be described with reference to FIG. 2 showing a principle of the FMCW method. In FIG. 2, a horizontal axis represents a time, and a vertical axis represents an optical frequency. There is a difference Δt in arrival time to the light receiver 113 between reference light 201 (L11), which is received as reference light and obtained by splitting by the optical fiber coupler 109, and received measurement light 202 (L12A) reflected by the target 114 in FIG. 1. Since a frequency of the light source changes during this time, a beat signal having a beat frequency fb equal to a frequency difference thus obtained is detected. When a frequency sweep width is Av and a time required for modulation by Av is T, a relationship of Equation (1) is obtained. Further, since a distance L to the measurement target is half a distance that the light travels during the Δt, the distance L can be calculated as in Equation (2) using a light velocity c in the atmosphere.

$$\begin{matrix}[ Math . 1 ] & \\ Δ t = \frac{T}{2 Δ v} {f}_{b} & ( 1 )\end{matrix}$$

$$\begin{matrix}[ Math . 2 ] & \\ L = \frac{cT}{2 Δ v} {f}_{b} & ( 2 )\end{matrix}$$

The distance L and the beat frequency have a linear relationship. Therefore, when the measurement signal L4 obtained by the light receiver 113 is subjected to first Fourier transform (FFT) to obtain a peak position and size, a reflection position and a reflected light amount of the target are obtained. FIGS. 3a and 3b show an example of a detection beat signal and a reflection intensity profile obtained by performing the FFT on the signal. FIG. 3a shows an interference beat signal obtained by the light receiver. A frequency of the interference beat signal is proportional to the distance to the target. In addition, FIG. 3b shows a result obtained by performing the FFT on the interference beat signal. When a horizontal axis is an axis indicating a frequency of the FFT and a vertical axis is a reflection intensity in FIG. 3b, data near a peak is discrete as shown in FIG. 3b. Here, a peak width w is calculated by a distance resolution cT/2Δν. Therefore, as shown in FIG. 3b, when a quadratic function or a function referred to as a Gaussian function is applied using three or more points near a peak point 301, and a peak of the applied function is used, it is possible to determine a position of the measurement target with an accuracy greater than or equal to the distance resolution. Although the FFT is described as an example of the analysis of the beat frequency, for example, a maximum entropy method may be used to detect the peak position with a resolution higher than that of the FFT.

FIGS. 3a and 3b show ideal results obtained when distance measurement is performed using only a specific polarization component. In reality, light whose polarization direction is orthogonal to the specific polarization component leaks in the optical fiber. The light leaks since, for example, an extinction ratio of an optical element of the optical fiber is low. Alternatively, when an optical fiber connector is used, the extinction ratio is reduced due to a fitting state between connectors.

FIGS. 4a, 4b, and 4c show detection beat signal waveforms obtained when the light leaks. FIG. 4a shows an interference beat signal obtained by the light receiver. Reference numeral 401 denotes a beat signal obtained by a polarization component to be originally measured. Reference numeral 402 denotes a beat signal obtained by a leaking light component orthogonal thereto. An amplitude ratio of the beat signals 401 and 402 is about the same as the extinction ratio. In addition, when the polarization component to be originally measured passes through a slow axis of the optical fiber and the leaking light component orthogonal thereto passes through a fast axis of the optical fiber, the beat signal 401 and the beat signal 402 have a distance difference corresponding to an amount of the light passing through the slow axis and the fast axis of the optical fiber, respectively. For example, in FIG. 1, an interference origin of the FMCW method is present between the fiber focuser 112 and the measurement target 114. Here, the interference origin refers to a position where a distance difference between the reference light 201 and the measurement light 202 shown in FIG. 2 is equal. For example, a distance from an optical fiber focuser to the interference origin is 200 mm. In this case, an optical fiber length of the reference optical path to be equal to the length is 200 mm×2 (reciprocating optical path): 1.5 (refractive index of optical fiber)=300 mm. Here, when a wavelength of the measurement light is 1.55 μm and a beat length of the optical fiber (distance by which the wavelength of the light passing through the fast axis and the slow axis is shifted by one cycle) is 5 mm, the optical path difference between the light passing through the fast axis and the light passing through the slow axis is 300 mm: 5 mm×1.55 μm=93 μm.

FIG. 4b shows a result obtained by performing the FFT on the beat signal shown in FIG. 4a. Reference numeral 403 denotes a peak intensity as a result of performing the FFT on a component of the beat signal 401 (passing through the slow axis of the optical fiber), and reference numeral 404 denotes a peak intensity as a result of performing the FFT on a component of the beat signal 402 (transmitting the fast axis of the optical fiber). Reference numeral 405 denotes a component obtained by combining 403 and 404. Here, when heat is applied to the optical fiber, a stress acts on the optical fiber, and a phase of the component of the fast axis with respect to the slow axis changes, so that a phase of 404 with respect to 403 changes. At this time, when the peak width (w shown in FIG. 3b) determined by the optical frequency sweep width is wider than 93 μm (optical path difference between the slow axis and the fast axis of the optical fiber), plain portions of 403 and 404 overlap each other, so that a peak detection position of the combined component 405 changes. Therefore, a distance error is generated.

FIG. 4c shows a distance error generated when heat is applied to the optical fiber. A horizontal axis represents a true distance, and a vertical axis represents a measured distance. The measured distance obtained in an ideal case where no light leaks to the fast axis is 406. Here, when a temperature change is applied to the fiber, a distance offset fluctuation is generated. Although an offset fluctuation amount varies depending on a phase state of the fast axis with respect to the slow axis, for example, at a certain phase, the measured distance is larger than the true distance as indicated by 407, and at a certain phase, the measured distance is smaller than the true distance as indicated by 408.

Therefore, in Embodiment 1 of the invention, as shown in FIG. 1, the polarizer 108 (the orthogonal polarization component attenuating element) is inserted into the optical path on a light L1 side, and by transmitting only a specific linear polarization component, for example, passing through the slow axis, and reducing the light leaking to the fast axis, it is possible to reduce a measurement error due to the temperature of the optical fiber. In FIG. 1, an insertion position of the polarizer 108 is set between the coupler 103 and the coupler 109, but the insertion position may be set downstream the coupler 109 or the circulator 111. Further, the insertion position may be between the coupler 109 and the coupler 110, between the circulator 111 and the coupler 110, or between the coupler 110 and the light receiving machine 113.

When a connector is used to connect optical fiber elements, the connection between the optical fiber elements is desirably fusion since the extinction ratio may decrease depending on the fitting state of the connectors. In addition, instead of inserting the polarizer, the couplers 103 and 109 having a high extinction ratio may be used. In this case, it is also desirable to fuse the laser 101 and the coupler 103. However, since the laser is a consumable part, regular replacement is necessary. For the regular replacement, connector connection is desirable. In this case, the polarizer 108 is provided upstream the coupler 103, and the coupler 103 and the polarizer 108 are fused to each other. In this way, even when the extinction ratio decreases due to using of a connector between the laser and the polarizer, the leaking light component can be attenuated by the polarizer, and thus a high extinction ratio can be maintained. The coupler may be 103 or 109, and a type that blocks the fast axis may be used.

The configuration example of the distance measurement device 100 is shown in FIG. 1 above, and a concept of the device configuration in Embodiment 1 is, in short, to adopt “a distance measurement method including: branching light generated by the laser light source 101 into a reference optical system and a measurement optical system; detecting a reference optical path measurement beat signal from the reference light L3 that passed through the reference optical system; detecting a measurement optical path measurement beat signal from the measurement light L4 obtained in the measurement optical system via the measurement target 114; and measuring a distance to the measurement target based on the measurement optical path measurement beat signal and the reference optical path measurement beat signal, in which a polarization-induced distance error reduction element (108 or 801 and 802 that reduces a distance error induced by polarization is provided in one or both of the reference optical system and the measurement optical system”, and a specific implementation technique showing this processing method is shown in FIG. 1 as an example. Although the following embodiments will be mainly described in terms of a device configuration, a method using this configuration can be replaced with a method using the method.

### Embodiment 2

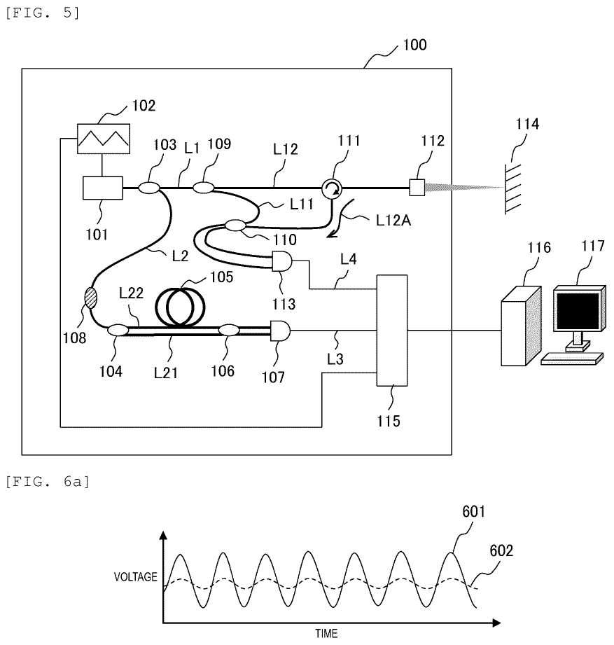

In Embodiment 2, the method using the orthogonal polarization component attenuating element will be described. FIG. 5 shows a configuration example of the distance measurement device 100 according to Embodiment 2 of the invention. In FIG. 1, the polarizer (the orthogonal polarization component attenuating element) is inserted into the measurement optical system (light L1 side) in order to reduce a measurement error induced by polarization, but a similar measurement error due to the polarization may also be generated in the reference optical system (light L2 side). Therefore, FIG. 5 shows a configuration in which the polarizer 108 (the orthogonal polarization component attenuating element) is inserted upstream the optical fiber coupler 104 to allow only a specific polarization component to pass through.

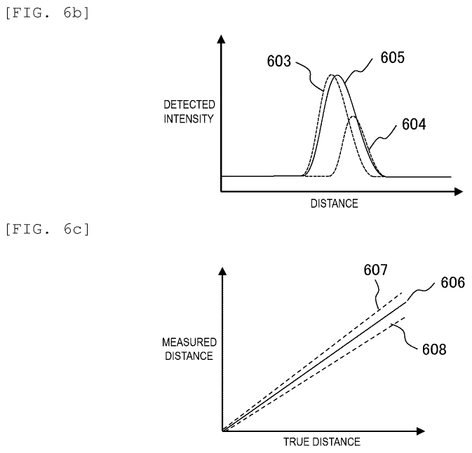

FIGS. 6a, 6b, and 6c show detection beat signal waveforms obtained when light leaks. FIG. 6a shows an interference beat signal obtained by a light receiver. Reference numeral 601 denotes a beat signal obtained by a polarization component to be originally measured. Reference numeral 602 denotes a beat signal obtained by a leaking light component of polarized light orthogonal thereto. An amplitude ratio of the beat signals 601 and 602 is about the same as the extinction ratio. In addition, when the polarization component to be originally measured passes through a slow axis of an optical fiber and the leaking light component orthogonal thereto passes through a fast axis of the optical fiber, the beat signal 601 and the beat signal 602 have a distance difference corresponding to an amount of the light passing through the slow axis and the fast axis of the optical fiber, respectively. For example, a length of the fiber 106 in FIG. 5 is 300 mm. Here, when a wavelength of measurement light is 1.55 μm and a beat length of the optical fiber (distance by which a wavelength of the light passing through the fast axis and the slow axis is shifted by one cycle) is 5 mm, an optical path difference between the light passing through the fast axis and the light passing through the slow axis is 300 mm: 5 mm×1.55 μm=93 μm.

FIG. 6b shows a result obtained by performing FFT on the beat signal shown in FIG. 6a. Reference numeral 603 denotes a peak intensity as a result of performing the FFT on a component of the beat signal 601 (passing through the slow axis of the optical fiber), and reference numeral 604 denotes a peak intensity as a result of performing the FFT on a component of the beat signal 602 (transmitting the fast axis of the optical fiber). Reference numeral 605 denotes a component obtained by combining 603 and 604. Here, when heat is applied to the optical fiber, a stress acts on the optical fiber, and a phase of the component of the fast axis with respect to the slow axis changes, so that a phase of 604 with respect to 603 changes. At this time, when a peak width (w shown in FIG. 3b) determined by an optical frequency sweep width is wider than 93 μm (optical path difference between the slow axis and the fast axis of the optical fiber), plain portions of 603 and 604 overlap each other, so that a peak detection position of the combined component 605 changes. Therefore, a distance error is generated.

FIG. 6c shows a distance error generated when heat is applied to the optical fiber. A horizontal axis represents a true distance, and a vertical axis represents a measured distance. The measured distance obtained in an ideal case where no light leaks to the fast axis is 606. Here, when a temperature change is applied to the fiber, an influence of the beat signal 602 is added to the reference beat signal 601, a resampling timing is shifted, and a gain fluctuation of the distance is generated. Although a gain fluctuation amount varies depending on a phase state of the fast axis with respect to the slow axis, for example, at a certain phase, a gain is larger than the true distance as indicated by 607, and at a certain phase, the gain is smaller than the true distance as indicated by 608. It should be noted here that when the light leaks in the measurement optical system, an offset error of the distance is generated as shown in FIGS. 4a, 4b, and 4c, but when the light leaks in the reference optical system, a gain error of the distance is generated as shown in FIGS. 6a, 6b, and 6c, and errors are generated in different ways.

In order to reduce the gain fluctuation of the distance, as shown in FIG. 5, the polarizer 108 is inserted to allow transmitting only the slow axis, and the light leaking to the fast axis is reduced, whereby it is possible to reduce a measurement error due to the temperature of the optical fiber.

When a connector is used to connect optical fiber elements, fusion is desirable since the extinction ratio may decrease depending fitting state of the connectors. In addition, instead of inserting the polarizer, the couplers 103 and 109 having a high extinction ratio may be used. In this case, it is also desirable to fuse the laser 101 and the coupler 103. However, since the laser is a consumable part, regular replacement is necessary. For the regular replacement, connector connection is desirable. In this case, the polarizer 108 is provided upstream the coupler 103, and the coupler 103 and the polarizer 108 are fused to each other. In this way, even when the extinction ratio decreases due to using of a connector between the laser and the polarizer, the leaking light can be cut by the polarizer, and thus a high extinction ratio can be maintained. The coupler may be 103 or 105, and a type that blocks the fast axis may be used.

### Embodiment 3

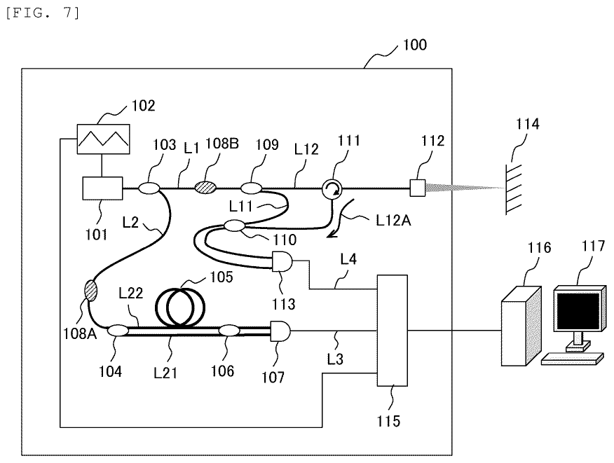

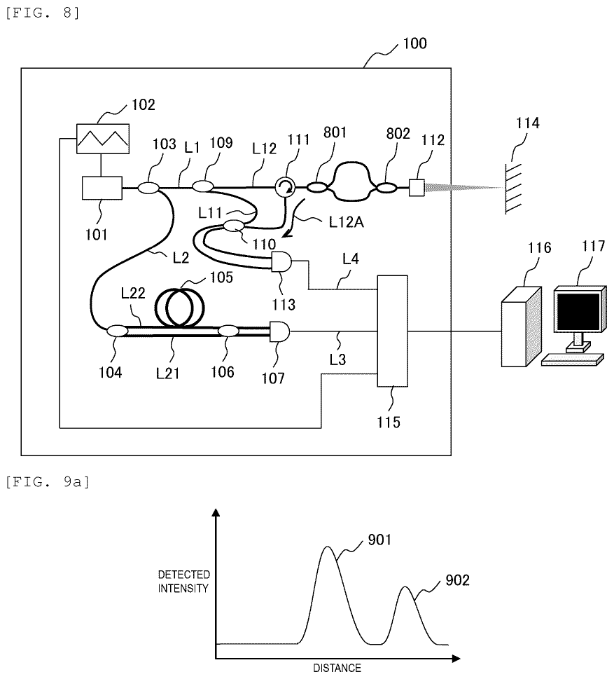

In Embodiment 3, the method using the orthogonal polarization component attenuating element will be described. FIG. 7 shows a configuration example of the distance measurement device 100 according to Embodiment 3 of the invention. FIG. 7 shows a configuration in which polarizers are inserted into both a measurement optical system (light L1 side) and a reference optical system (light L2 side). By inserting a polarizer 108B into the measurement optical system (light L1 side) as described in Embodiment 1, it is possible to prevent an offset fluctuation of a distance induced by polarization. A polarizer insertion position may be downstream the coupler 109 or the circulator 111. Further, it may be between the coupler 109 and the coupler 110, between the circulator 111 and the coupler 110, or between the coupler 110 and the light receiving machine 113.

Further, as described in Embodiment 2, by inserting a polarizer 108A in the reference optical system (light L2 side), it is possible to prevent a gain fluctuation of the distance induced by polarization. The insertion position of the polarizer 108A may be upstream the coupler 103. In this case, since the same effect as that of the polarizer 108B inserted into the measurement optical system is produced, the polarizer 108B may be omitted. However, it is assumed that the coupler 103 holds an extinction ratio equivalent to that of the polarizer. Optical fiber elements are desirably fused to each other to maintain a high extinction ratio.

### Embodiment 4

In Embodiment 4 and subsequent embodiments, the method using the inter-polarization component optical path difference generating element will be described. FIG. 8 shows a configuration example of the distance measurement device 100 according to Embodiment 4 of the invention. Embodiment 1 to Embodiment 3 have the configuration in which the orthogonal polarization component attenuating element (polarizer 108) is inserted as the polarization-induced distance error reduction element into the measurement optical system or the reference optical system to allow only a specific polarization component to pass through.

On the other hand, a method of using the inter-polarization component optical path difference generating element as a method for implementing the polarization-induced distance error reduction element will be described below. However, since a configuration of a measurement optical system or a reference optical system in the distance measurement device 100 according to Embodiment 4 in FIG. 8 is basically the same as that in FIG. 1, the description thereof is omitted here. The only difference is that a measurement error induced by polarization is reduced by providing a distance difference between a slow axis component and a fast axis component of an optical fiber, so that the following description will focus on this point for the subject.

Specifically, in FIG. 8, the polarization beam splitter 801 is provided downstream the circulator 111 to split the light L12 into two components (slow axis and fast axis) having orthogonal polarization. After an optical path difference is provided by changing an optical fiber length between the two components obtained by splitting, the light is again combined by the polarization beam combiner 802. The combined light is guided to the optical fiber focuser 112 to irradiate a target.

In FIG. 8, the polarization beam splitter 801 and the polarization beam combiner 802 are inserted downstream the circulator 111, and may be inserted upstream the circulator 111. Further, the polarization beam splitter 801 and the polarization beam combiner 802 may be between the optical fiber couplers 109 and 110 or between the circulator 111 and the optical fiber coupler 110. In short, FIG. 8 shows a method for implementing the polarization-induced distance error reduction element on the measurement optical system side, in which the inter-polarization component optical path difference generating elements (the polarization beam splitter 801 and the polarization beam combiner 802) are provided. Optical fiber elements are desirably fused to each other to maintain a high extinction ratio.

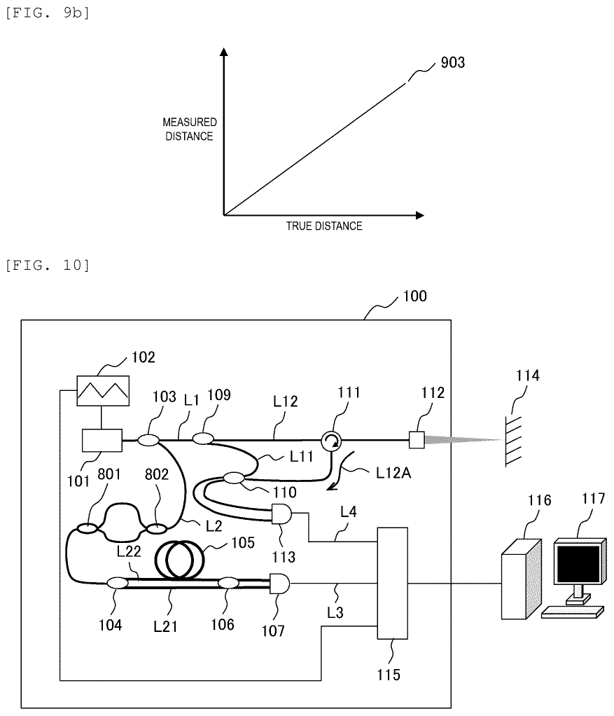

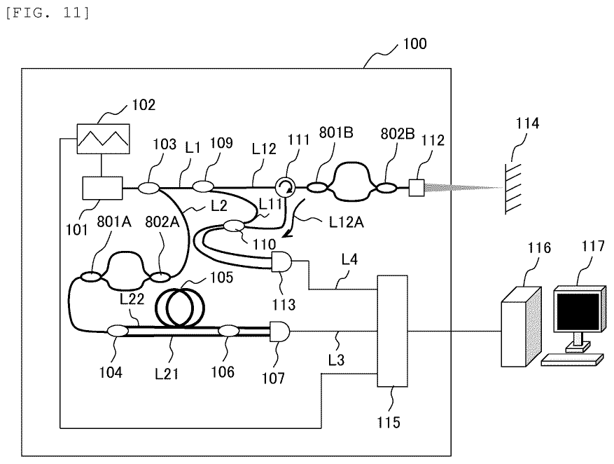

FIG. 9a shows a result obtained by performing FFT on a beat signal obtained by the light receiver 113. Reference numeral 901 denotes a peak intensity of an FFT spectrum obtained by a beat component transmitting the slow axis, and reference numeral 902 denotes a peak intensity of an FFT spectrum obtained by the beat component transmitting the fast axis. Since the optical path difference is provided by the polarization beam splitter 801 and the polarization beam combiner 802, a peak position can be separated by a peak width (w in FIG. 3b) or more determined by an optical frequency sweep width. In this case, even when a phase of leaking light fluctuates and a phase of the peak intensity 902 changes, the peak intensity 901 is not influenced, and thus a distance error is not generated.

FIG. 9b shows a generated distance error. A horizontal axis represents a true distance, and a vertical axis represents a measured distance. The measured distance obtained when no light leaks to the fast axis is 903. In FIGS. 4a, 4b, and 4c, an offset error is generated when the phase of the leaking light changes, but in FIGS. 9a and 9b, an offset error of the distance is not generated even when the phase of the leaking light changes.

### Embodiment 5

FIG. 10 shows a configuration example of the distance measurement device 100 according to Embodiment 5 of the invention. In Embodiment 4, a distance difference is provided between polarization components orthogonal to each other by inserting the polarization beam splitter 801 and the polarization beam combiner 802 into the measurement optical system, but in Embodiment 5, a similar method is used in a reference optical system. The optical fiber coupler 103 branches light into the light L1 and the light L2, and the light L1 guided to the reference optical system is split by the polarization beam splitter 801 into two components (slow axis and fast axis) having orthogonal polarization. After an optical path difference is provided between the two components, light is again combined by the polarization beam combiner 802 and guided to the optical coupler 104. Here, by setting the distance difference between the polarized light to be equal to or larger than the peak width (w in FIG. 3b) determined by the optical frequency sweep width, it is possible to prevent a gain fluctuation induced by polarization.

### Embodiment 6

FIG. 11 shows a configuration example of the distance measurement device 100 according to Embodiment 6 of the invention. FIG. 11 shows a configuration in which a polarization beam splitter and a polarization beam combiner are inserted into both a measurement optical system and a reference optical system.

As described in Embodiment 4, by inserting a polarization beam splitter 801B and a polarization beam combiner 802B into the measurement optical system, it is possible to prevent the offset fluctuation of the distance induced by polarization. Further, as described in Embodiment 5, by inserting a polarization beam splitter 801A and a polarization beam combiner 802A into the reference optical system, it is possible to prevent the gain fluctuation of the distance induced by polarization.

### Embodiment 7

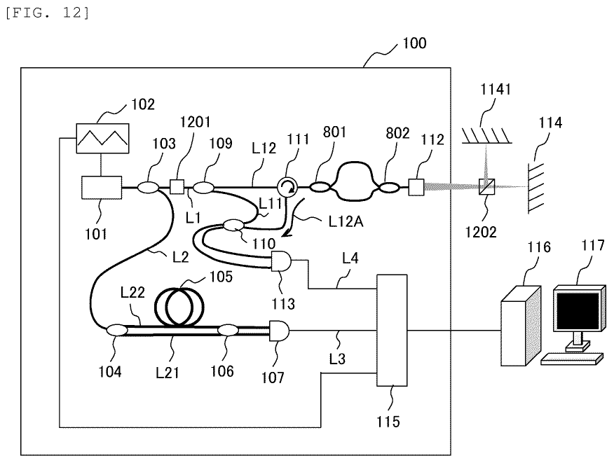

FIG. 12 shows a configuration example of the distance measurement device 100 according to Embodiment 7 of the invention. In this configuration, a polarization switching device 1201 and a polarization beam splitter 1202 are added to the configuration in FIG. 8 of Embodiment 4 in order to switch a measurement direction. Polarization of transmitting light emitted from the laser 101 be can switched by the polarization switching device 1201. A space from the fiber focuser 112 is irradiated with the light that passed through the fiber coupler 109, the circulator 111, the polarization beam splitter 801, and the polarization beam combiner 802. An irradiation direction of the light with which the polarization beam splitter 1202 is irradiated can be switched depending on a polarization state thereof. For example, since light oscillating in parallel to an incident surface of the polarization beam splitter 1202 transmits, the measurement target 114 is irradiated, and since light oscillating in a direction perpendicular to the incident surface is reflected, a measurement target 1141 is irradiated.

At this time, by using the polarization beam splitter 801 and the polarization beam combiner 802, both polarization components can be transmitted, and thus it is possible to cope with the switching of the measurement direction using a polarization switching device.

On the other hand, when the polarizer 108 described in FIG. 1 of Embodiment 1 is used, since only polarized light in one direction passes, the measurement direction cannot be switched. By using the polarization beam splitter 801 and the polarization beam combiner 802, there is an advantage that both polarized light can be passed while preventing an offset of a distance induced by polarization.

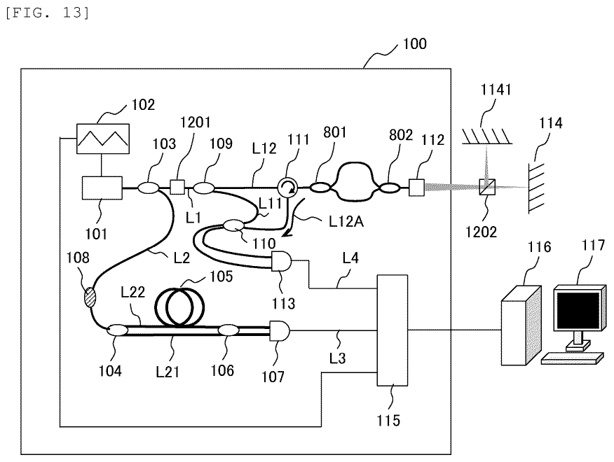

FIG. 13 shows a configuration in which the polarizer 108 is inserted into the reference optical system in addition to the configuration in FIG. 12, in order to prevent a gain fluctuation of the distance induced by polarization. Since the reference optical system does not perform polarization switching, the reference optical system may have a configuration to allow only one polarization to pass through by inserting the polarizer 108. However, a configuration using a polarization beam splitter 1001 and a polarization beam combiner 1002 described in FIG. 10 may be adopted.

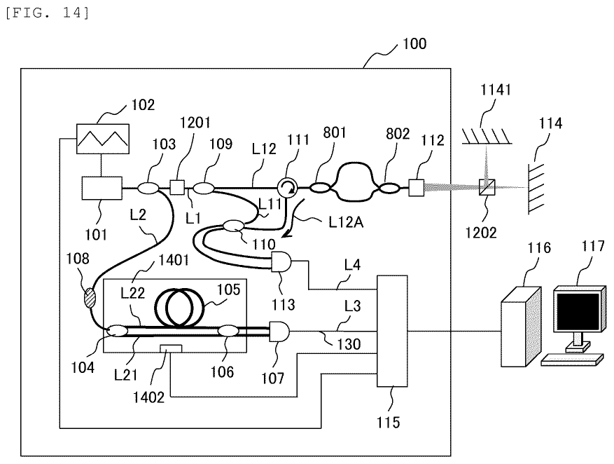

FIG. 14 shows a configuration in which a reference fiber interferometer portion (the optical couplers 104 and 106, and the optical fiber 105) serving as a distance reference is covered with a heat insulating box 1401, a temperature in the heat insulating box is measured by a temperature sensor 1402, and a measured value 130 is sent to the distance measurement device 115 in addition to the configuration in FIG. 13, thereby correcting a change in optical path length due to heat of the optical fiber. With this configuration, an optical path length difference in the reference optical system serving as the distance reference can be accurately obtained, and highly accurate distance measurement can be performed.

### Embodiment 8

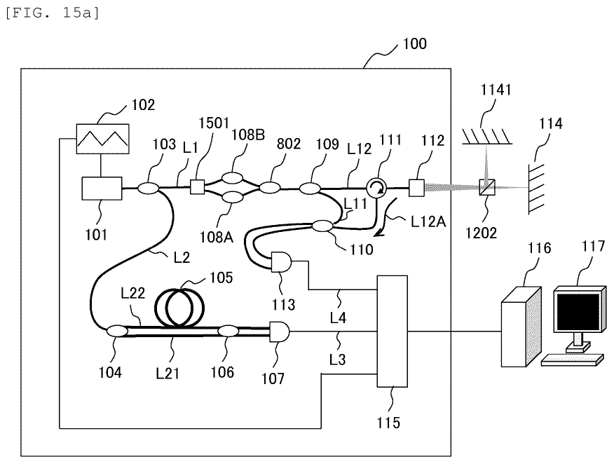

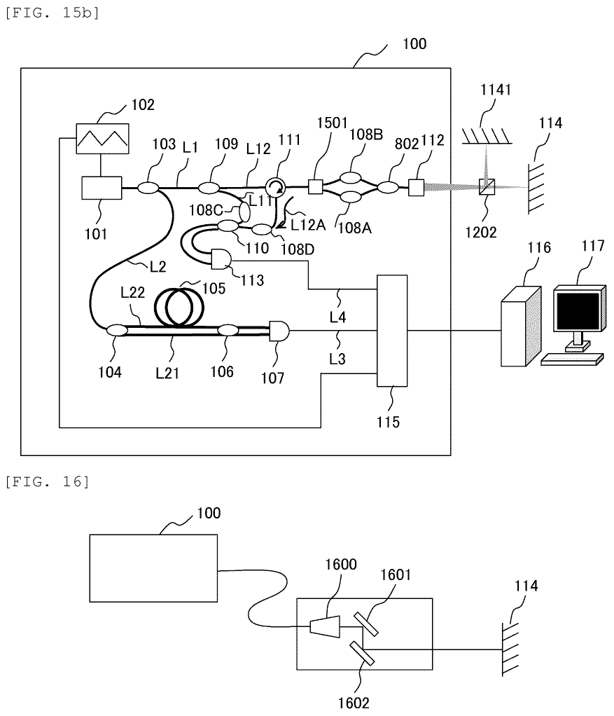

FIG. 15a shows a configuration example of the distance measurement device 100 according to Embodiment 8 of the invention. In FIG. 12, the polarization switching device 1201 is used to switch the measurement direction, but an optical switch 1501 is used instead. The light L1 emitted from the laser light source 101 and passed through the optical coupler 103 is branched into two optical paths by the optical switch 1501. The polarizer 801A is inserted into one optical path. Thereafter, the light is guided to the polarization beam combiner 802. The polarizer 801B is inserted into the other optical path. A fast axis and a slow axis of an optical fiber are inverted with respect to the light that passed through the polarizer 801B, and the optical fiber is fused to the polarization beam combiner 802. In this way, it is possible to split the light branched into two beams by the optical switch 1501 into different polarization components. Since the optical switch 1501 mechanically switches the optical path, the optical switch 1501 is characterized in that leaking light has no polarization. Therefore, a high extinction ratio can be maintained for a configuration using a polarization beam combiner.

FIG. 15b shows a configuration in which an insertion position of the optical switch is changed with respect to FIG. 15a. In FIG. 15b, by disposing the optical switch 1501 downstream the circulator, a measurement target can be irradiated at an extinction ratio determined by the polarizers 108A and 108B and the polarization beam combiner 802 without depending on the extinction ratio of the coupler 109 or the circulator 111. Further, in this configuration, since only one polarized light passes through the optical switch 1501, an influence of the leaking light can be reduced by inserting polarizers 108C and 108D into the interferometer.

### Embodiment 9

Next, a configuration example of a shape measurement device will be described with reference to FIGS. 16 to 24 in Embodiment 9 to Embodiment 13.

First, FIG. 16 is a diagram showing a configuration example of a distance measurement system according to Embodiment 9 of the invention. Light emitted from the distance measurement device 100 is guided by an optical fiber, and is emitted from an optical fiber focuser 1600 to a space. Beam scanning is performed by using beam scanning mechanisms 1601 and 1602, and the target 114 is two-dimensionally scanned. As the beam scanning mechanism, the beam scanning may be performed by using a galvanometer mirror. It is possible to perform scanning one-dimensionally by using one galvanometer mirror, and it is possible to perform scanning two-dimensionally by using two galvanometer mirrors. Further, the scanning mechanism may be an MEMS mirror, a polygon mirror, and scanning may be performed by another mechanism capable of deflecting light.

### Embodiment 10

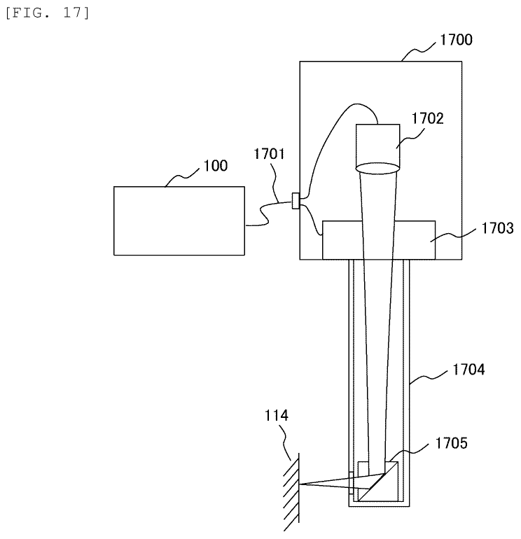

FIG. 17 is a diagram showing a configuration example of a distance measurement system according to Embodiment 10 of the invention. Light emitted from the distance measurement device 100 is guided to a measurement head 1700 by an optical fiber 1701. The light guided into the measurement head 1700 is emitted from an optical fiber focuser 1702 to a space. A probe shaft 1704 is attached to a rotary motor 1703, and a prism 1705 is attached to a tip of the probe shaft. A measurement target 1706 is irradiated with the light reflected by 1705, and the reflected light is reflected again by the prism 1705 and is condensed by the optical fiber focuser 1702. The prism 1705 at the tip is rotated by rotation of the rotary motor 1703, and a cross-sectional shape of the target 1706 can be measured.

### Embodiment 11

FIG. 18 is a diagram showing a configuration example of a distance measurement system according to Embodiment 11 of the invention. Light emitted from the distance measurement device 100 is guided to the measurement head 1700 by the optical fiber 1701, and is emitted from the optical fiber focuser 1702 to a space. Light of linearly polarized light guided from the distance measurement device 100 is converted into circularly polarized light by a λ/4 plate 1707, and then passes through a λ/4 plate 1708 attached to the rotary motor 1703 to be linearly polarized light again. The polarization beam splitter 1705 attached to a tip of the probe 1704 reflects or transmits the light according to a polarization direction and irradiates the measurement targets 114 and 1141 with the light. At this time, by switching the polarized light by the polarization switching device 1201 mounted in the distance measurement device 100 in FIG. 4, it is possible to perform switching between a side surface measurement direction and a depth measurement direction.

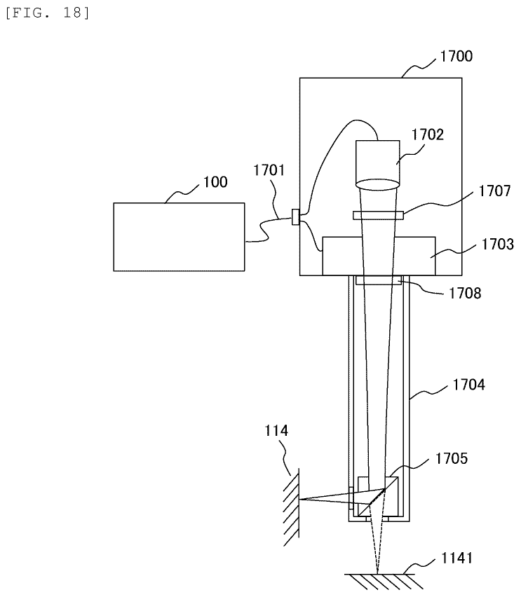

A principle of switching the measurement direction using polarized light at the tip of the probe will be described with reference to FIG. 19. The polarization beam splitter 1705 at the tip of the probe has a property of transmitting light (P polarized light) oscillating parallel to an incident surface and reflecting light (S polarized light) oscillating in a direction perpendicular to the incident surface. Therefore, by electrically switching polarized light of a distance measuring laser to the P polarized light and the S polarized light by the polarization switching device 1201, an irradiation direction of the distance measuring laser can be switched between a side direction and a depth direction.

In order to rotate a measurement beam keeping the measurement beam in the side direction, it is necessary to rotate a polarization direction of incident light 1901 according to rotation of the polarization beam splitter and keep a polarization state relative to the polarization beam splitter constant.

Therefore, two λ/4 plates 1707 and 1708 are used. By disposing an axis of the first λ/4 plate 1707 at 45 degrees with respect to the polarization direction of the incident light 1901, linearly polarized light is converted into circularly polarized light. The second λ/4 plate 1708 and the polarization beam splitter 1705 are attached to a rotary motor and rotate together with the motor. By passing through the second λ/4 plate 1708, the circularly polarized light is converted into linearly polarized light again, and it is possible to maintain a normally constant polarized light incident direction with respect to the polarization beam splitter 1705 together with the rotation of the motor, and to rotate the beam in the side direction.

### Embodiment 12

FIG. 20 is a diagram showing a configuration example of a distance measurement system according to Embodiment 12 of the invention. FIG. 20 shows an example of a configuration including a scanning mechanism for scanning the distance measurement head 1700. By mounting the distance measurement head 1700 on a Z-axis stage 2006, the measurement head 1700 can be moved up and down. In addition, the measurement target 114 is mounted on an X-axis stage 2004 and a Y-axis stage 2005, and the measurement target 114 can be moved in a horizontal direction. A three-dimensional shape of the measurement target 114 can b measured by positioning the measurement target 114 in the horizontal direction with respect to the measurement head 1700 and then moving the measurement head 1700 in an upper-lower direction.

A moving stage is driven by a stage controller 2008 via a wiring 2007. The stage controller 2008 is controlled by the control PC 116.

As an example of the scanning mechanism, by holding the measurement head 1700 according to the invention instead of a tool in a three-axis machine tool, it is possible to implement machine tool on-machine measurement. In addition, it is possible to implement a three-dimensional shape measurement device for measuring the shape of the measurement target 114 by holding and moving the measurement head 1700 according to the invention with a multi-degree-of-freedom robot. In addition, when a measurement target range is narrow and the shape can be measured only by a movement in the Z-axis direction, the position of the measurement target 114 may be uniquely determined by a jig, and the measurement may be performed by moving only the Z-axis stage.

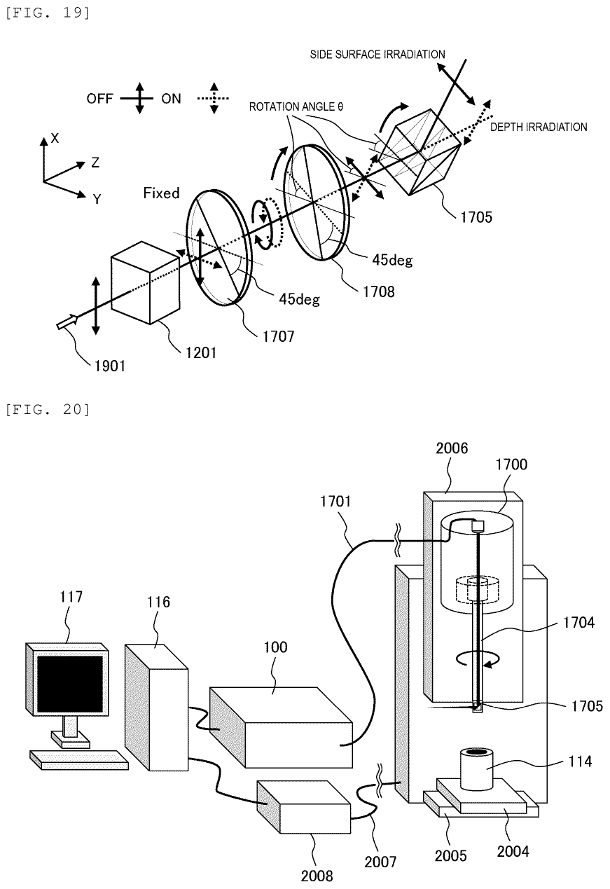

FIG. 21 shows a system configuration example of a shape measurement device shown in FIG. 20. The measurement head 1700 is controlled by the distance measurement device 100, to measure the distance to the measurement target. The distance measured by the distance measurement device 100 is input to a distance calculation unit 2101 in the control PC 116, and a measured distance value and a rotation stage encoder signal are associated with each other.

A stage mechanism 2103 includes a XYZ-axis stage shown in FIG. 20, and a position thereof is controlled by a stage controller 2108. The three-dimensional shape of the target can be measured by processing, by a shape calculator 2102, stage coordinates acquired by the stage controller 2108 and a distance measurement result obtained by the distance calculation unit 2101. A measurement result is displayed on the display unit 117.

### Embodiment 13

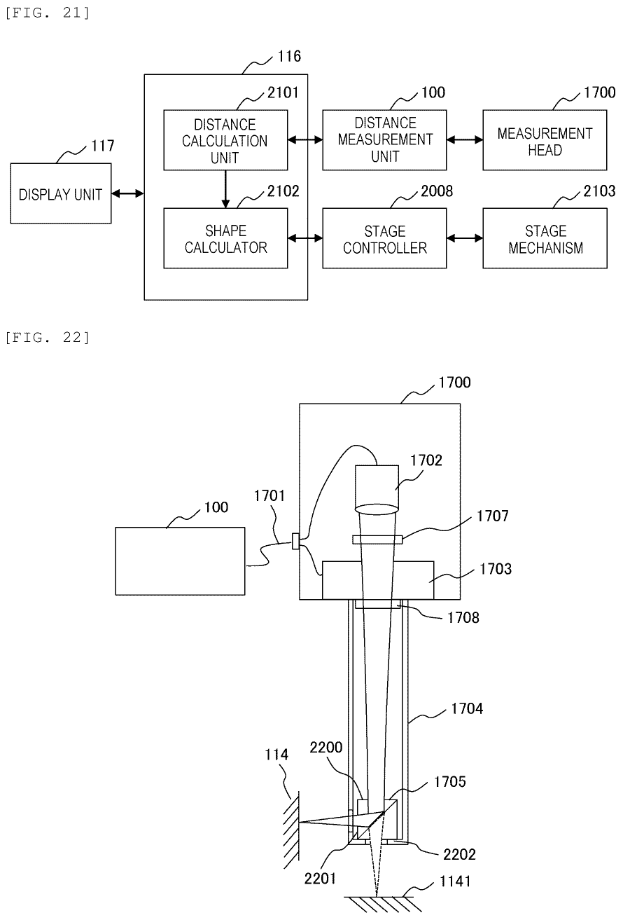

FIG. 22 shows an embodiment different from that in FIG. 18. In FMCW distance measurement, as described in FIG. 12, the light split by the coupler 109 in the distance measurement t device 100 and the reflected light from the measurement target 114 are combined by the coupler 110, and the distance difference during this time is measured. Here, an optical path to the measurement target 114 after splitting by the coupler 109 becomes a measurement error since an optical path length of an optical fiber element or the like changes due to an influence of heat or the like. Therefore, it is conceivable to correct a distance origin for the purpose of improving a measurement accuracy.

As an embodiment of distance origin correction, a reflective coating 2200 for generating the distance origin is applied to an incident surface of the polarization beam splitter 1705. Since a material of the polarization beam splitter is generally a glass, a surface reflectance is about 4% without coating. Although depending on sensitivity of the light receiver to be used, when the reflectance is too large and the light receiver is saturated, it is necessary to adjust the reflectance to 4% or less by surface coating. Further, since reflection on polarization beam splitter emission surfaces 2201 and 2202 causes noise, it is necessary to prevent the reflection as much as possible. Therefore, an antireflection film is provided. A general antireflection film has a reflectance of 0.1% or less.

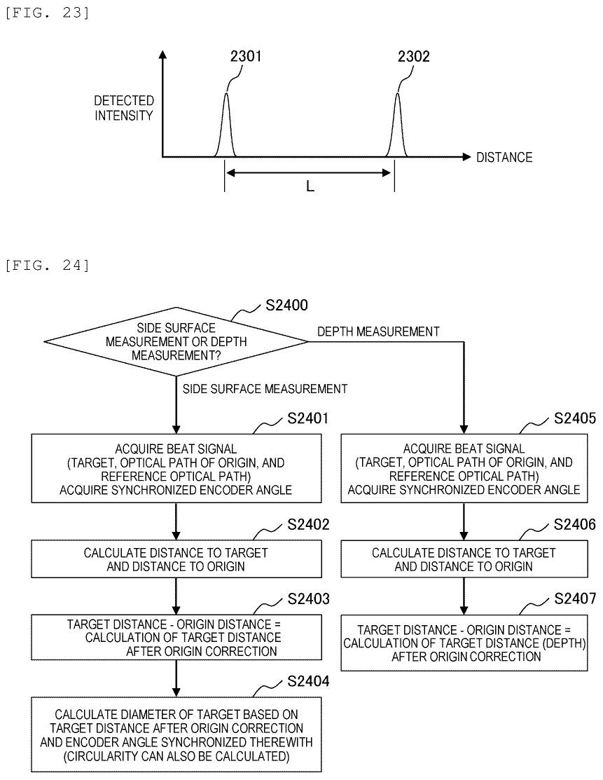

FIG. 23 is a diagram showing an FFT result of a detection beat signal obtained by the configuration in FIG. 22. A measurement peak of the incident surface of the polarization beam splitter 1705 used as the distance origin is 2301. On the other hand, a measurement peak from the measurement target 114 after transmitting the polarization beam splitter is 2302. The distance origin correction can be performed by subtracting the peak distance 2301 from the peak distance 2302.

FIG. 24 shows a processing flow of the origin correction. In processing step S2400, it is determined whether side surface measurement or depth measurement is to be performed. In the case of the side surface measurement, a beat signal is acquired in processing step S2401. Further, an encoder signal of the rotary motor whose acquisition timing is synchronized with the beat signal is acquired. In processing step S2402, the distance to the measurement target and the distance to the origin are calculated. In processing step S2403, the origin distance is subtracted from the measurement target distance to calculate a measurement target distance after the origin correction. Further, in processing step S2404, a target diameter is calculated based on the target distance after the origin correction and the encoder signal of the rotary motor synchronized therewith. Further, not only the diameter but also a circularity can be calculated. It is also possible to calculate a three-dimensional shape by combining with the measurement head scanning coordinates described in FIG. 20.

In the case of the depth measurement, a beat signal is acquired in processing step S2405. In processing step S2406, the distance to the measurement target and the distance to the origin are calculated. In processing step S2407, the origin distance is subtracted from the measurement target distance to calculate a measurement target distance after the origin correction. It is also possible to calculate a three-dimensional shape by combining with the measurement head scanning coordinates described in FIG. 20.

### Embodiment 14

In the configuration of Embodiment 1, only a specific polarization component transmits using the polarizer, but an embodiment of a configuration using a component other than the polarizer is shown in FIG. 25. Light emitted from an optical fiber 2501a becomes parallel light by a lens 2502a, and a polarization beam splitter 2503 is irradiated with the parallel light. In the polarization beam splitter 2503, light is split according to a polarization direction, one polarized light transmits, and the other polarized light is reflected. The reflected light is absorbed by an absorbing material 2506, and the transmitted light is guided to the optical fiber 2501a by a lens 2502b, thereby achieving the same effect as the polarizer.

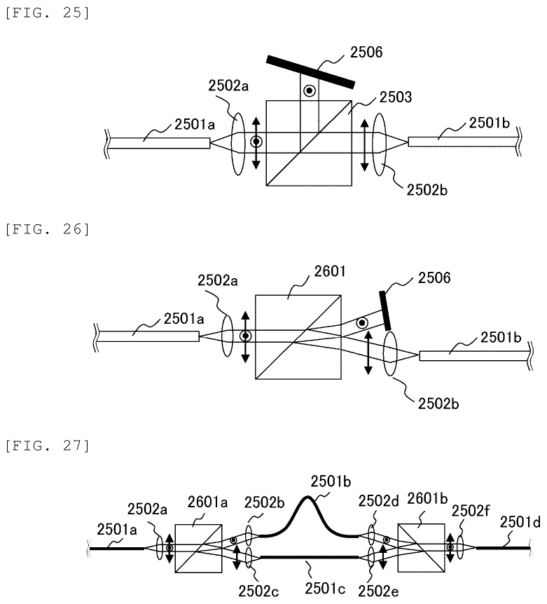

In addition, an element having a birefringence may be used as an element that splits light depending on the polarization direction. An embodiment using the element having a birefringence is shown in FIG. 26. The light emitted from the optical fiber 2501a becomes parallel light by the lens 2502a, and an element 2601 having a birefringence is irradiated with the parallel light. Since a refractive index of the light passing through 2601 varies depending on polarized light, a difference is generated in traveling angle. Therefore, one polarized light is absorbed by the absorbing material 2506, and the other polarized light is guided to an optical fiber 2501b by the lens 2502b, thereby achieving the same effect as the polarizer.

### Embodiment 15

In the configuration of Embodiment 4, polarized light is split/combined using the polarization beam splitter/polarization beam combiner to provide the optical path difference between polarization components, and a configuration in which light is split/combined depending on a polarization direction using an element having a birefringence may also be used. An embodiment in a case where the element having a birefringence is used is shown in FIG. 27. Light emitted from the optical fiber 2501a becomes parallel light by the lens 2502a, and an element 2601a having a birefringence is irradiated with the parallel light. Since a refractive index of the light passing through 2601a varies depending on polarized light, a difference is generated in traveling angle. Therefore, one polarized light is guided to the optical fiber 2501b by the lens 2502b, and the other polarized light is guided to an optical fiber 2501c by a lens 2502c. Here, the optical fibers 2501b and 2501c have different lengths. The light emitted from the optical fiber 2501b becomes parallel light by a lens 2502d, and an element 2601b having a birefringence is irradiated with the parallel light. In addition, the light emitted from the optical fiber 2501c becomes parallel light by a lens 2502e, and the element 2601b having a birefringence is irradiated with the parallel light. Both the two beams of light are again combined into the same optical path by the element 2601b having a birefringence, and guided to an optical fiber 2501d by a lens 2502f. With this configuration, the polarization beam splitter/polarization beam combiner has the same function.

### Embodiment 16

In Embodiment 1 to Embodiment 8, the configuration example using the optical fiber is shown as one embodiment, but for example, a system in which an interferometer is configured in a space using an optical element that branches and combines light in the space may be used.

Further, a photonic integrated circuit may be used to form a waveguide, a coupler, a circulator, a polarizing element (polarizer, polarization beam splitter), and a detector on a substrate, and a system may be provided using the photonic integrated circuit in which some or all of optically necessary elements and functions for implementing the embodiments described in Embodiment 1 to Embodiment 8 are formed on a substrate.

### REFERENCE SIGNS LIST

100: distance measurement device
101: semiconductor laser
102: oscillator
103, 104, 106, 109, 110: optical fiber coupler
105: optical fiber
107: light receiver
108: polarizer
111: circulator
112: optical fiber focuser
113: light receiver
114, 1141: measurement target
115: distance measurement device control unit
116: control device
117: display unit
201: reference light
202: measurement light
301: FFT peak waveform
401: beat signal obtained by polarization component of main component
402: beat signal obtained by polarization component of leaking light
403: FFT intensity profile obtained by polarization component of main component
404: FFT intensity profile obtained by polarization component of leaking light
405: FFT intensity profile obtained by combining main component and polarization component of leaking light
406: measured distance value obtained when no thermal fluctuation is generated
407: measured distance value obtained when thermal fluctuation is generated
408: measured distance value obtained when thermal fluctuation is generated
601: beat signal obtained by polarization component of main component
602: beat signal obtained by polarization component of leaking light
603: FFT intensity profile obtained by polarization component of main component
604: FFT intensity profile obtained by polarization component of leaking light
605: FFT intensity profile obtained by combining main component and polarization component of leaking light
606: measured distance value obtained when no thermal fluctuation is generated
607: measured distance value obtained when thermal fluctuation is generated
608: measured distance value obtained when thermal fluctuation is generated
801: polarization beam splitter
802: polarization beam combiner
901: FFT intensity profile obtained by polarization component of main component
902: FFT intensity profile obtained by polarization component of leaking light
903: measured distance value obtained when no thermal fluctuation is generated
1201: polarization switching device
1202: polarization beam splitter
1401: heat insulating box
1402: temperature sensor
1501: optical switch
1600: optical fiber focuser
1601: beam scanner
1602: beam scanner
1700: measurement head
1701: optical fiber
1702: optical fiber focuser
1703: rotary motor
1704: shaft
1705: polarization beam splitter
1707: λ/4 plate
1708: λ/4 plate
1901: laser light
2004: X-axis stage
2005: Y-axis stage
2006: Z-axis stage
2007: wiring cable
2008: stage controller
2101: distance calculation unit
2102: shape calculation unit
2103: stage mechanism
2200: reflective coat
2201: antireflection coat
2202: antireflection coat
2301: distance origin detection peak
2302: target detection peak
2501: optical fiber
2502: lens
2503: polarization beam splitter
2506: absorbing material
2601: element having birefringence

1. A distance measurement method comprising:
branching light generated by a laser light source into a reference optical system and a measurement optical system;
detecting a reference optical path measurement beat signal from reference light that passed through the reference optical system;
detecting a measurement optical path measurement beat signal from measurement light obtained in the measurement optical system via a measurement target; and
measuring a distance to the measurement target based on the measurement optical path measurement beat signal and the reference optical path measurement beat signal, wherein
a polarization-induced distance error reduction element is provided in one or both of the reference optical system and the measurement optical system.

2. The distance measurement method according to claim 1, wherein
the polarization-induced distance error reduction element is an orthogonal polarization component attenuating element that transmits a specific linear polarization component of the light generated by the laser light source and that attenuates a polarization component orthogonal thereto.

3. The distance measurement method according to claim 1, wherein
the polarization-induced distance error reduction element is an inter-polarization component optical path difference generating element including an element for providing an optical path difference between a specific linear polarization component of the light generated by the laser light source and a polarization component orthogonal thereto.

4. The distance measurement method according to claim 3, wherein
the optical path difference between the specific linear polarization component of the light generated by the laser light source and the polarization component orthogonal thereto is equal to or larger than a line width of a peak of a spectrum obtained by Fourier transform of the measurement optical path measurement beat signal.

5. The distance measurement method according to claim 1, wherein
a polarization switching element for switching polarization of the light generated by the laser light source and an element for switching an irradiation direction to a target according to a polarization direction are provided in one or both of the reference optical system and the measurement optical system.

6. The distance measurement method according to claim 1, wherein
at least a part of the reference optical system is accommodated in a storage box, a temperature of the storage box is measured, and a change in optical path length due to a temperature of the reference optical system is corrected using the temperature.

7. A distance measurement device comprising:
a light branching unit configured to branch light generated by a laser light source;
a reference optical system configured to obtain reference light serving as a reference of a distance by guiding one of the branched light;
a measurement optical system configured to obtain, as measurement light, reflected light after the other one of the branched light is guided to irradiate a measurement target;
a first light receiving unit configured to receive the reference light that passed through the reference optical system and detect a reference optical path measurement beat signal;
a second light receiving unit configured to receive the measurement light reflected by the measurement target in the measurement optical system and detect a measurement optical path measurement beat signal; and
a polarization-induced distance error reduction element provided in one or both of the reference optical system and the measurement optical system, wherein
a distance to the measurement target is measured based on the measurement optical path measurement beat signal and the reference optical path measurement beat signal.

8. A distance measurement system comprising:
a light branching unit configured to branch light generated by a laser light source;
a reference optical system configured to obtain reference light serving as a reference of a distance by guiding one of the branched light;
a measurement optical system configured to obtain, as measurement light, reflected light after the other one of the branched light is guided to irradiate a measurement target;
a first light receiving unit configured to receive the reference light that passed through the reference optical system and detect a reference optical path measurement beat signal;
a second light receiving unit configured to receive the measurement light reflected by the measurement target in the measurement optical system and detect a measurement optical path measurement beat signal;
a polarization-induced distance error reduction element provided in one or both of the reference optical system and the measurement optical system; and
a scanning mechanism configured to perform, when the measurement target is irradiated with irradiation light in the measurement optical system, scanning with the irradiation light one-dimensionally, two-dimensionally, or three-dimensionally, wherein
a distance to the measurement target is measured based on the measurement optical path measurement beat signal and the reference optical path measurement beat signal.
